(19) United States
(12) Patent Application Publication
(10) Pub. No.: US 2026/0179254 A1
(43) Pub. Date: Jun. 25, 2026

(54) SYSTEM AND METHOD FOR IDENTIFYING MISCALIBRATION OR MISALIGNMENT OF REAR-FACING PERCEPTION SENSORS

(71) Applicant: Torc Robotics, Inc., Blacksburg, VA (US)

(72) Inventors: Vicent Rodrigo Marco, Stuttgart (DE); Yann Labou, Portland, OR (US); Shile Li, Muenchen (DE); Marco Busch, Muenchen (DE); Rubing Wang, Stuttgart (DE); Alexander Little, Herndon, VA (US)

(21) Appl. No.: 18/988,396

(22) Filed: Dec. 19, 2024

(51) Int. Cl. G06T 7/80; G01S 13/931; G01S 17/931; G06T 7/70

(52) U.S. Cl. CPC G06T 7/80; G01S 13/931; G01S 17/931; G06T 7/70; G01S 2013/93272

(57) ABSTRACT

An autonomy computing system includes at least one memory configured to store machine executable instructions, and at least one processor coupled to the at least one memory. The at least one processor is configured to execute the machine executable instructions to perform operations including (i) receiving sensor data from a rear facing sensor mounted on an autonomous vehicle and expressed in a sensor coordinate system; (ii) determining a vehicle coordinate system of the autonomous vehicle based upon the sensor coordinate system; (iii) determining a vehicle coordinate system of a trailer coupled with the autonomous vehicle based upon the sensor coordinate system and the sensor data; (iv) computing a hitch angle between the autonomous vehicle and the trailer while the autonomous vehicle coupled with the trailer is in a non-turning phase; and (v) determining the rear facing sensor needs calibration based upon the hitch angle exceeding a predetermined threshold value.

### TECHNICAL FIELD

The field of the disclosure relates generally to perception technologies for autonomous vehicles and, more specifically, real-time identification of miscalibration or misalignment of rear-facing sensors.

### BACKGROUND OF THE INVENTION

Autonomous vehicles employ fundamental technologies such as, perception, localization, behaviors and planning, and control. Perception technology enables an autonomous vehicle to sense and process its environment. Perception technology processes a sensed environment to identify and classify objects, or groups of objects, in the environment, for example, pedestrians, vehicles, or debris. Localization technology determines, based on the sensed environment, for example, where in the world, or on a map, the autonomous vehicle is. Localization technology processes features in the sensed environment to correlate, or register, those features to known features on a map. Localization technology may rely on inertial navigation system (INS) data. Behaviors and planning technology determines how to move through the sensed environment to reach a planned destination. Behaviors and planning technology processes data representing the sensed environment and localization or mapping data to plan maneuvers and routes to reach the planned destination for execution by a controller or a control module. Controller technology uses control theory to determine how to translate desired behaviors and trajectories into actions undertaken by the vehicle through its dynamic mechanical components. This includes steering, braking and acceleration.

Generally, perception technology and localization technology are based on sensor data from multiple sensors requiring a fusion of sensor data from various sensors and measurement technologies, or sensor modalities. The fusion of sensor data from various sensors and measurement technologies is generally known as multi-source and multi-modal sensor fusion. Multi-modal sensor fusion enables key functions in automated driving systems such as, for example, motion estimation, localization, or environment recognition. Multi-source and multi-modal sensor fusion enables autonomous vehicles to overcome limitations and uncertainties associated with relying on sensor data from a single sensor source. However, misalignment errors cause significant risks to sensor fusion algorithms for object detection and tracking, motion estimation, or localization.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system including at least one memory configured to store machine executable instructions and at least one processor coupled to the at least one memory is disclosed. The at least one processor is configured to execute the machine executable instructions to perform operations including: (i) receiving sensor data from a rear facing sensor mounted on an autonomous vehicle, wherein the sensor data is expressed in a sensor coordinate system; (ii) determining a vehicle coordinate system of the autonomous vehicle based upon the sensor coordinate system; (iii) determining a vehicle coordinate system of a trailer coupled with the autonomous vehicle based upon the sensor coordinate system and the sensor data; (iv) computing a hitch angle between the autonomous vehicle and the trailer while the autonomous vehicle coupled with the trailer is in a non-turning phase, wherein the hitch angle corresponds to an angular difference in an alignment of the vehicle coordinate system of the trailer and the vehicle coordinate system of the autonomous vehicle; and (v) determining the rear facing sensor needs calibration based upon the hitch angle exceeding a predetermined threshold value.

In another aspect, a computer-implemented method is disclosed. The computer-implemented method includes: (i) receiving sensor data from a rear facing sensor mounted on an autonomous vehicle, wherein the sensor data is expressed in a sensor coordinate system; (ii) determining a vehicle coordinate system of the autonomous vehicle based upon the sensor coordinate system; (iii) determining a vehicle coordinate system of a trailer coupled with the autonomous vehicle based upon the sensor coordinate system and the sensor data; (iv) computing a hitch angle between the autonomous vehicle and the trailer while the autonomous vehicle coupled with the trailer is in a non-turning phase, wherein the hitch angle corresponds to an angular difference in an alignment of the vehicle coordinate system of the trailer and the vehicle coordinate system of the autonomous vehicle; and (v) determining the rear facing sensor needs calibration based upon the hitch angle exceeding a predetermined threshold value.

In yet another aspect, an autonomous vehicle including at least one memory configured to store machine executable instructions, and at least one processor coupled to the at least one memory, and a rear facing perception sensor mounted on a tractor of the autonomous vehicle is disclosed. The at least one processor is configured to execute the machine executable instructions to perform operations including (i) receiving sensor data from the rear facing perception sensor, wherein the sensor data is expressed in a sensor coordinate system; (ii) determining a vehicle coordinate system of the autonomous vehicle based upon a sensor coordinate system of the rear facing perception sensor; (iii) determining a vehicle coordinate system of a trailer coupled with the autonomous vehicle based upon the sensor coordinate system and the sensor data; (iv) computing a hitch angle between the autonomous vehicle and the trailer while the autonomous vehicle coupled with the trailer is in a non-turning phase, wherein the hitch angle corresponds to an angular difference in an alignment of the vehicle coordinate system of the trailer and the vehicle coordinate system of the autonomous vehicle; and (v) determining the rear facing perception sensor needs calibration based upon the hitch angle exceeding a predetermined threshold value.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is an illustration of an example tractor-trailer having a miscalibration or misalignment of a perception sensor; and

FIG. 5 is a flow diagram of an embodiment method of real time detection of a miscalibration or misalignment of a perception sensor or a tractor-trailer using a rear facing perception sensor.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

A sensor coordinate system: A sensor coordinate system is a local coordinate system defining a position and an orientation of a sensor mounted in a vehicle or mounted on a body of the vehicle. An origin of the sensor coordinate system is the mounting position of the sensor. An X-axis in the sensor coordinate system points in the direction of the sensor as defined by the mounting orientation. Furthermore, values of sensor data generated by a sensor are in the sensor coordinate system of the respective sensor.

A vehicle coordinate system: A vehicle coordinate system is a system of axes defining a position and an orientation of a vehicle in space. The vehicle coordinate system is one of several coordinate systems used in vehicles, along with the world coordinate system (e.g., an absolute coordinate system) and the sensor coordinate system.

As described herein, an integration of data from various sensors and measurement technologies, also referenced herein as a multi-source and multi-modal sensor fusion, plays an essential role to overcome the limitations and uncertainties associated with relying on a single sensor source for key functions like motion estimation, localization, or environment recognition. However, for effective multi-source and multi-modal sensor fusion based on the information or sensor data from different sensors, it is imperative to have a comprehensive understanding of the transformations, rotations, and translations, among the different sensors as well as between the vehicle and the sensors.

However, errors in vehicle assembly techniques for mass-production, or tolerances in the manufacturing processes, may cause errors in the orientation of the sensors. The errors in the orientation of sensors may be referenced herein as misalignment sensors. The sensors may be perception sensors mounted within a vehicle. The perception sensors may include one or more of RADAR sensors, one or more LiDAR sensors, or one or more imaging sensors such as, cameras. Additionally, or alternatively, during the vehicle operation, due to wear, strong vibrations, or physical damage, the sensor's orientation may get altered with respect to a vehicle reference frame compared to the sensor's original end-of-line orientation. These unaccounted orientation errors (or misalignment errors) may deteriorate the performance of sensor fusion algorithms, and may further lead to safety hazards due to, for example, inaccurate object detection and tracking, and motion estimation or localization.

The disclosed systems and methods identify, in real-time, misalignment errors for perception sensors and determine appropriate correction for the misalignment errors. Generally, a truck, or tractor, is configured with perception sensors including one or more RADAR sensors, one or more LiDAR sensors, or one or more imaging sensors (e.g., camera sensors). At least some of the perception sensors are mounted rear facing such that a trailer (or at least a portion of the trailer) coupled with the tractor is in a field of view of each such perception sensor. For reasons described above, such as wear, strong vibrations, or physical damage, for example, the physical damage caused by debris strike, the sensor's orientation may be altered with respect to a vehicle reference frame compared to the sensor's original orientation at manufacture, or “end-of-line.” The end-of-line orientation refers to a factory set calibration or alignment of a sensor with the vehicle reference frame (or the vehicle coordinate system). Real time detection of such misalignment error enables compensation for the misalignment error when it occurs. Conversely, conventional calibration or alignment methods are offline or not in real time, and such conventional calibration methods rely on a predefined target object with well-defined shapes and positions. While such offline calibration methods are effective in identifying RADAR misalignments, a dedicated infrastructure and significant time and effort are needed for the calibration procedure. Moreover, such calibration methods are not suitable to perform calibration online during operation of an autonomous vehicle. Alternatively, other methods for RADAR or LiDAR extrinsic calibration entail precise measurements of the position and orientation of the RADAR or LiDAR sensors relative to the vehicle. However, these methods require additional “ground equipment,” i.e., separate from the autonomous vehicle, capable of accurately measuring the position and orientation of the RADAR or LiDAR sensors within the vehicle, rendering such methods unsuitable for online calibration.

Some alternative methods calibrate RADAR or LiDAR sensors to other perception modalities (e.g., cameras) by leveraging environment features perceived by both sensors to identify the misalignment between the sensors. While such approaches do not require pre-defined targets and are suitable for online calibration, they require both sensor types perceive the same environment features. Accordingly, these methods often require the environment to have specific features, involve substantial computational processing for the feature extraction and matching, and require accurate ego-motion information for precise spatio-temporal alignment of the identified features. Other known strategies rely on high-definition digital maps and environments rich in RADAR sensitive structural elements to guarantee a successful identification of the RADAR to vehicle transform.

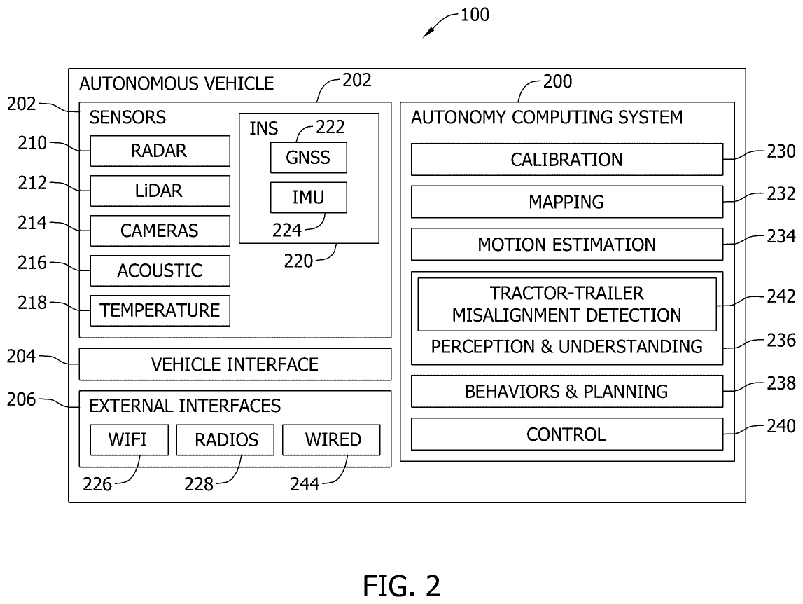

The disclosed systems and methods for RADAR or LiDAR sensor online calibration monitoring are tailored for a real-time integrated operation. The integrated solution according to an example embodiment employs information or sensor data from a single RADAR or LiDAR sensor and ubiquitous vertical angular rate measurements or angular velocity measurements, and thereby eliminates the need for additional perception sensors. Additionally, the approach, according to at least some embodiments described herein, is distinguished further by its simplicity, because it avoids the complexities associated with high-definition mapping or specific environmental features that require advanced feature recognition. The disclosed systems and methods identify misalignments of RADAR or LiDAR sensors by perceiving the trailer and without relying on dedicated infrastructure or additional equipment, which enables online, or real time, identification of misalignments of RADAR or LiDAR sensors. The systems and methods disclosed herein are implemented at, or performed by, for example, an autonomy computing system that is described herein with reference to FIG. 2.

In an example embodiment, a method of detecting misalignment or miscalibration of a perception sensor may include detecting or identifying sensor data of rear facing perception sensors. The rear facing perception sensors may be mounted on a trailer or a tractor. Based upon a specific position of the rear facing perception sensors, the sensor data of the rear facing perception sensors may include a distinct rectangular shape associated with the trailer coupled to the tractor. By way of an example, the distinct rectangular shape associated with the trailer for each perception sensor may be unique based on the position of the perception sensor. Accordingly, a machine learning algorithm trained to identify the distinct rectangular shape of the trailer based upon the perception sensor's position may be used to identify misalignment or miscalibration of the perception sensor.

Additionally, in certain embodiments, based upon the sensor data of a perception sensor, a relative yaw angle between the trailer and the current position of the perception sensor may be determined. Using the known orientation of the perception sensor to the tractor, a hitch angle or a relative yaw angle between the tractor and the trailer may also be identified. The hitch angle or the relative yaw angle between the tractor and the trailer is defined as an angle between a longitudinal centerline axis of the tractor and a longitudinal centerline axis of the trailer. Further, vertical angular rate measurements may be used to detect when the tractor-trailer is turning. Vertical angular rate measurements may be derived from various sources such as inertial sensors, wheel speed, steering data, or alternative odometry sources. Similarly, angular velocity measurements may also indicate whether the tractor-trailer is turning. Angular velocity refers to a rate of change of a rotational angle over time. While angular velocity is analogous to linear velocity, it provides information about change in an angle instead of a distance.

Accordingly, in certain embodiments, while the tractor-trailer is in a non-turning phase, a misalignment of the tractor-trailer may be identified or determined based upon the hitch angle or relative yaw angle between the tractor and the trailer. For example, based on the kinematic differential equations governing the hitch angle, while the tractor-trailer is in a non-turning phase, the hitch angle or the relative yaw angle between the tractor and the trailer tends to be zero with a rate of convergence that is dependent on the velocity such that the larger velocity causes the convergence to zero more rapidly.

Accordingly, in certain embodiments, based on the hitch angle or the relative yaw angle computed using the sensor data of the rear facing perception sensor, and velocity measurements, whether the trailer is aligned with the tractor, such that the hitch angle is zero, may be determined. By way of an example, the velocity measurements may be obtained from a global navigation satellite system (GNSS), wheel speeds, or alternative sources of odometry. If the velocity measurements indicate the tractor-trailer is not in a non-turning phase, the hitch angle or the relative yaw angle is expected to be close to or equal to zero. A hitch angle above a predetermined threshold value, for example, 0.2 degree such that the hitch angle is more than +/−0.2 degree, may indicate a misalignment of the trailer with the tractor that poses a safety risk to the tractor-trailer operation. Upon detecting the misalignment of the trailer with the tractor is above the predetermined threshold value, the tractor-trailer may be pulled over to prevent a safety risk to the tractor-trailer. Additionally, while the misalignment of the trailer with the tractor is within the predetermined threshold value, an appropriate correction to the perception sensor data may be made for a multi-source multi-modal fusion of sensor data.

The disclosed systems and methods provide for the identification of misalignments in perception sensors (for example, LiDAR, RADAR, or camera sensors) having their respective field of view encompassing the trailer when its coordinate system is roughly aligned with a coordinate system of the tractor, e.g., an autonomous vehicle or truck. Using a kinematic model, the time evolution of the hitch angle, θ, can be expressed as follows using a differential equation:

$$\dot{θ ( t )} = - \frac{v ( t )}{{l}_{2}} sin ( θ ( t ) ) - \dot{ψ ( t )} [ 1 - \frac{{l}_{h} cos ( θ ( t ) )}{{l}_{2}} ] , \qquad Eq . 1$$

In Eq. 1 above, l₂ is the distance between the rear axle of the trailer and the hitch point, lₕ is the distance between the rear axle of the tractor and the hitch point, v is the velocity of the tractor, and ψ is the yaw rate of the tractor.

Based on the differential equation, whenever the yaw rate of the tractor is zero and the vehicle is moving forward, the hitch angle will tend to zero at a rate depending on the speed of the vehicle. After a transient period of time, the tractor and trailer should be aligned, and the hitch angle should be zero.

The disclosed systems and methods employ vertical angular rate measurements to detect when the tractor-trailer is not turning. As described herein, these vertical angular rate measurements can be derived from various sources such as inertial sensors, wheel speed and steering data, or alternative odometry sources. Alternatively, steering angle measurements can be used, leveraging the following kinematic relationship:

$$\dot{ψ ( t )} = v ( t ) \frac{tan ( δ ( t ) )}{{l}_{1}} , \qquad Eq . 2$$

In Eq. 2 above, l₁ corresponds with the wheelbase of the tractor, and δ is the steering angle of the front wheels.

A sensor (for example, LiDAR, RADAR, or camera sensor) aligned with a field of view encompassing the trailer when its coordinate system, i.e., the trailer coordinate system, is roughly aligned with that of the tractor, tracks the angle between the trailer and the sensor coordinate system. Using the known sensor-to-vehicle orientation, a measurement of the hitch angle can be computed, using Eq. 1 above. When close-to-zero vertical angular rate is detected, a time is waited to ensure that the hitch angle has converged to zero. This can be verified, for example, by estimating the transient time leveraging the kinematic differential equation or by using the changes in the angle tracked by the sensor.

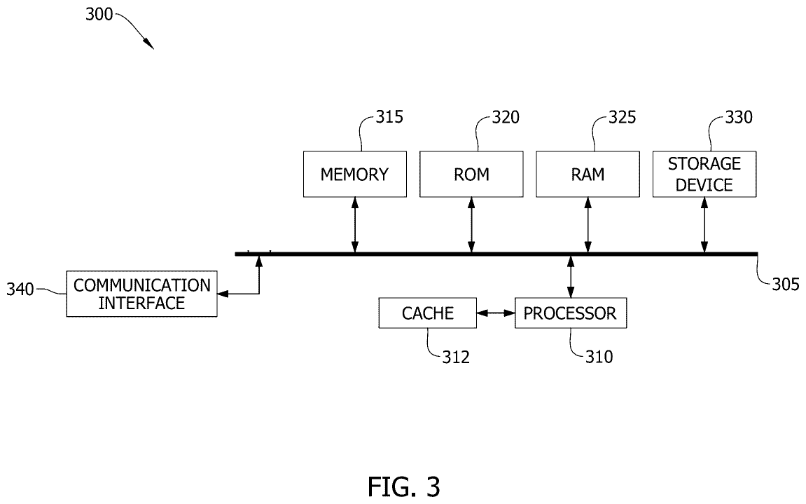

Once it is verified that the hitch angle has converged, the trailer angle measurements supplied by the perception sensor are supplied into an estimator that identifies the perception sensor misalignment. The estimator may be implemented, as a hardware or software module, on a computing system (shown and described herein with reference to FIG. 3) or an autonomy computing system (shown and described herein with reference to FIG. 2). It is assumed herein that while driving straight-ahead (without significant vertical angular rate) and after a convergence period, the hitch angle should be zero. A large deviation (for example, the hitch angle that is above a predetermined threshold value) from zero indicates a misalignment.

The estimator such as, a Kalman Filter or robust recursive least squares, may be used to track the hitch angle computed from the perception sensor. If the hitch angle is above a predetermined threshold value, it indicates the pre-configured perception sensor-to-vehicle orientation is incorrect, and, therefore, a misalignment has occurred. Moreover, angle estimates generated by the estimator can be used to correct the angular misalignment in the vertical degree of freedom. The disclosed systems and methods quickly identify the misalignment.

Additionally, assuming v, s, and t respectively denote the tractor, sensor and trailer coordinate systems. The sensor supplies the rotation between the trailer and the sensor coordinate system as

$${R}_{s}^{t} ,$$

which can be expressed as a rotation matrix from the sensor to the trailer coordinate system. From the known sensor extrinsic representing a position and an orientation of the sensor with the respect to the vehicle or trailer or another sensor, the rotation between the sensor and the tractor coordinate systems may be represented as

$${R}_{v}^{s} .$$

When driving straight ahead, the rotation between the tractor and the trailer (or hitch angle) should be approximately zero, i.e.,

$${R}_{v}^{t} \approx 0 ,$$

as shown below in Eq. 4.

$${R}_{v}^{t} = {R}_{s}^{t} {R}_{v}^{s} \approx 0 , \qquad Eq . 4$$

The combination of

$${R}_{s}^{t} {R}_{v}^{s}$$

being far from zero, indicates that the pre-configured perception sensor-to-tractor orientation in

$${R}_{v}^{s}$$

is incorrect and, hence, a misalignment has occurred. Eq. 5 shown below can be leveraged to identify or estimate the misalignment ΔR.

$${R}_{s}^{t} Δ R {R}_{v}^{s} \approx 0 , \qquad Eq . 5$$

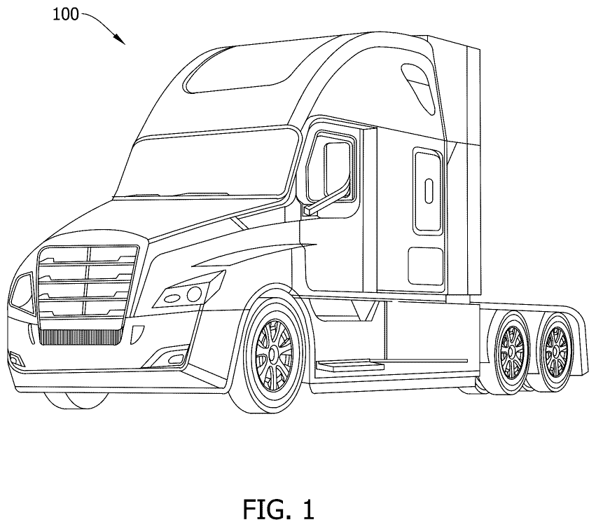

Various embodiments are described in detail herein using FIG. 1 to FIG. 5.

FIG. 1 illustrates a vehicle 100, such as a truck (or a tractor) that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a tractor-trailer misalignment detection module 242. The tractor-trailer misalignment detection module 242, for example, may be embodied within another module, such as perception and understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The tractor-trailer misalignment detection module 242 may determine misalignment of the trailer with the tractor based upon the computed hitch angle and the velocity measurements. Based upon the determined misalignment, the tractor-trailer misalignment detection module may also compute required adjustments to the sensor data of one or more perception sensors for fusion of sensor data.

FIG. 3 illustrates an example computing system 300 that can implement various techniques, processes, functions, or methods described herein. Computing system 300 may be embodied within, for example, autonomous vehicle 100 shown in FIG. 1. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

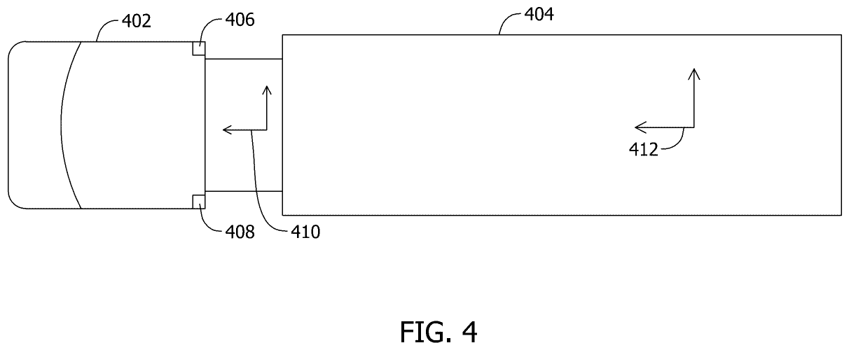

FIG. 4 is an illustration of an example tractor-trailer 400 having a miscalibration or misalignment of a perception sensor or a tractor-trailer using a rear facing perception sensor. In FIG. 4, a tractor 402 is coupled with a trailer 404. Rear facing perception sensors 406 and 408 may be mounted on the tractor 402, as shown in FIG. 4, such that at least a portion of the trailer 404 is in a FOV of the perception sensor 406 or 408. While the misalignment or miscalibration may be determined, e.g., by an autonomy computing system such as autonomy computing system 200 shown in FIG. 2, as described herein, using a single rear facing perception sensor, e.g., either sensor 406 or sensor 408. Alternatively, two or more sensors, e.g., sensor 406 and sensor 408, may be used for redundancy or for improving accuracy. A coordinate system 410 may correspond with a tractor coordinate system, and a coordinate system 412 may correspond with a trailer coordinate system.

Rear facing sensors 406 and 408 may include, for example, LiDAR sensor 212 or a RADAR sensor 210 shown in FIG. 2. Alternatively, rear facing sensors 406 and 408 may be an imaging sensor such as camera 214 shown in FIG. 2. Accordingly, the FOV of rear facing sensors 406 or 408 include at least a portion of the trailer 404 along with other objects in the FOV of rear facing perception sensors 406 or 408. Based upon the azimuth, elevation, and range of an object in sensor data of the perception sensor 406 or 408, the trailer 404 and its coordinate system 412 may be identified based upon a sensor coordinate system (not shown in FIG. 4) of the perception sensor 406 or 408. Further, based upon the sensor coordinate system of the perception sensor 406 or 408, the coordinate system 410 of the tractor 402 may be identified. Accordingly, based upon the sensor data of the perception sensor 406 or 408, an alignment of the tractor 402 (or the vehicle coordinate system 410) with the trailer 404 (or the vehicle coordinate system 412) may be determined. By way of an example, the alignment of the tractor 402 with the trailer 404 may be determined based upon sensor data of only one perception sensor, for example, the perception sensor 406 or the perception sensor 408. Alternatively, sensor data from the perception 406 and the perception sensor 408 may be alternatively or randomly selected for identifying alignment of the tractor 402 with the trailer 404.

In other words, while the tractor 402 coupled with the trailer 404 is going straight and not in a turning-phase, or while the tractor 402 and the trailer 404 are stationary or parked such that the tractor 402 and the trailer 404 are aligned, the vehicle coordinate system 410 and the vehicle coordinate system 412 computed based upon the sensor data of the perception sensor 406 or 408 should be aligned. However, when the vehicle coordinate system 410 and the vehicle coordinate system 412 computed based upon the sensor data of the perception sensor 406 or 408 are not aligned with each other, it may indicate or suggest the perception sensor 406 or 408 is not correctly calibrated or aligned. A correction for calibration or alignment of the perception sensor 406 or 408 may be required. Alternatively, based upon the misalignment computed based upon the sensor data of the perception sensor 406 or 408, an appropriate correction may be determined or applied to the sensor data of the perception sensor 406 or 408. As a result, multi-source multi-modal fusion may be accurately performed.

As described above, while the tractor-trailer is in a non-turning phase, a hitch angle or relative yaw angle between the tractor 402 and the trailer 404 may be determined as a difference in alignment of the vehicle coordinate system 410 and the vehicle coordinate system 412. If the hitch angle is within a predetermined threshold value, for example, 0.2 degree such that the hitch angle is not more than +/−0.2 degree, no correction may be applied to the sensor data of the perception sensor 406 or 408. However, if the hitch angle is found to be above the predetermined threshold value, calibration, or alignment of the perception sensor 406 or 408 may be needed. Additionally, or alternatively, the sensor data of the perception sensor 406 or 408 may be adjusted for the hitch angle that is above the predetermined threshold value. The tractor-trailer is in a non-turning phase or in a turning phase may be determined using vertical angular rate measurements derived from various sources such as inertial sensors, wheel speed, steering data, or alternative odometry sources.

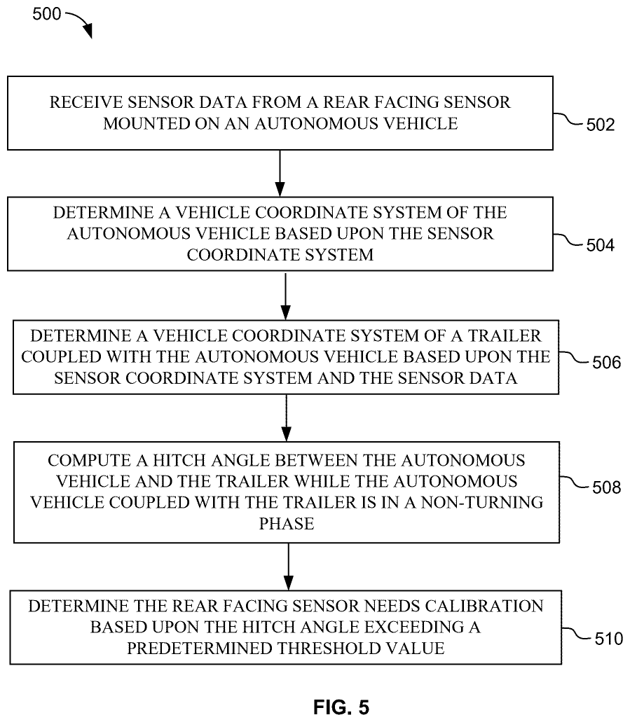

FIG. 5 is an example flow-chart 500 of an embodiment method of real time detection of a miscalibration or misalignment of a perception sensor or a tractor-trailer using a rear facing perception sensor. The method operations may be performed by the processor 310 (shown in FIG. 3) or tractor-trailer misalignment detection module 242 (shown in FIG. 2). The method operations may include receiving 502 sensor data from a rear facing sensor mounted on an autonomous vehicle. The received sensor data may be expressed in a sensor coordinate system. The rear facing sensor may be mounted on the autonomous vehicle. By way of an example, the rear facing sensor may include a LiDAR sensor, a RADAR sensor, or a camera sensor. The sensor data received from the rear facing sensor may include sensor data corresponding to at least a portion of the trailer in a field of view of the rear facing sensor. The portion of the trailer in the field of view may include a longitudinal side portion of the trailer.

The method operations may include determining 504 a vehicle coordinate system of the autonomous vehicle based upon the sensor coordinate system and determining 506 a vehicle coordinate system of a trailer coupled with the autonomous vehicle based upon the sensor coordinate system and the sensor data. The method operations may include computing 508 a hitch angle between the autonomous vehicle and the trailer while the autonomous vehicle coupled with the trailer is in a non-turning phase. The hitch angle may correspond to an angular difference in an alignment of the vehicle coordinate system of the trailer and the vehicle coordinate system of the autonomous vehicle. The method operations may include determining 510 the rear facing sensor needs calibration based upon the hitch angle exceeding a predetermined threshold value. Additionally, the method operations may also include determining whether the sensor data from the rear facing sensor needs to be adjusted for multi-source multi-modal sensor data fusion in response to the hitch angle exceeding the predetermined threshold value, as described herein. Additionally, or alternatively, whether the autonomous vehicle coupled with the trailer is in a non-turning phase is determined based upon angular velocity measurements or vertical angular rate measurements using gyro sensors or angular rate sensors mounted on the tractor or trailer.

An example technical effect of the methods, systems, and apparatus described herein includes at least improving safety of an autonomous vehicle as the autonomous vehicle can plan to operate in a manner that increases distance from the vehicle identified as being driven by a driver having a threat assessment score at or above a specific threshold value.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. An autonomy computing system comprising:
at least one memory configured to store machine executable instructions; and
at least one processor coupled to the at least one memory and configured to execute the machine executable instructions to perform operations comprising:
receiving sensor data from a rear facing sensor mounted on an autonomous vehicle, wherein the sensor data is expressed in a sensor coordinate system;
determining a vehicle coordinate system of the autonomous vehicle based upon the sensor coordinate system;
determining a vehicle coordinate system of a trailer coupled with the autonomous vehicle based upon the sensor coordinate system and the sensor data;
computing a hitch angle between the autonomous vehicle and the trailer while the autonomous vehicle coupled with the trailer is in a non-turning phase, wherein the hitch angle corresponds to an angular difference in an alignment of the vehicle coordinate system of the trailer and the vehicle coordinate system of the autonomous vehicle; and
determining the rear facing sensor needs calibration based upon the hitch angle exceeding a predetermined threshold value.

2. The autonomy computing system of claim 1, wherein the at least one processor is further configured to execute the machine executable instructions to determine whether the sensor data from the rear facing sensor needs to be adjusted for multi-source multi-modal sensor data fusion in response to the hitch angle exceeding the predetermined threshold value.

3. The autonomy computing system of claim 1, wherein receiving the sensor data from the rear facing sensor comprises receiving sensor data from a light detection and ranging (LiDAR) sensor.

4. The autonomy computing system of claim 1, wherein receiving the sensor data from the rear facing sensor comprises receiving sensor data from a radio detection and ranging (RADAR) sensor.

5. The autonomy computing system of claim 1, wherein receiving the sensor data from the rear facing sensor comprises receiving sensor data from the rear facing sensor including sensor data corresponding to at least a portion of the trailer in a field of view of the rear facing sensor.

6. The autonomy computing system of claim 5, wherein the portion of the trailer in the field of view is a longitudinal side portion of the trailer.

7. The autonomy computing system of claim 1, wherein the at least one processor is further configured to execute the machine executable instructions to determine whether the autonomous vehicle coupled with the trailer is in a non-turning phase is based upon angular velocity measurements or vertical angular rate measurements.

8. The autonomy computing system of claim 1, wherein the predetermined threshold value for determining the rear facing sensor needs calibration is the hitch angle more than +2 degree or less than −2 degree.

9. A computer-implemented method comprising:
receiving sensor data from a rear facing sensor mounted on an autonomous vehicle, wherein the sensor data is expressed in a sensor coordinate system;
determining a vehicle coordinate system of the autonomous vehicle based upon the sensor coordinate system;
determining a vehicle coordinate system of a trailer coupled with the autonomous vehicle based upon the sensor coordinate system and the sensor data;
computing a hitch angle between the autonomous vehicle and the trailer while the autonomous vehicle coupled with the trailer is in a non-turning phase, wherein the hitch angle corresponds to an angular difference in an alignment of the vehicle coordinate system of the trailer and the vehicle coordinate system of the autonomous vehicle; and
determining the rear facing sensor needs calibration based upon the hitch angle exceeding a predetermined threshold value.

10. The computer-implemented method of claim 9, further comprising determining whether the sensor data from the rear facing sensor needs to be adjusted for multi-source multi-modal sensor data fusion in response to the hitch angle exceeding the predetermined threshold value.

11. The computer-implemented method of claim 9, wherein receiving the sensor data from the rear facing sensor comprises receiving sensor data from a light detection and ranging (LiDAR) sensor.

12. The computer-implemented method of claim 9, wherein receiving the sensor data from the rear facing sensor comprises receiving sensor data from a radio detection and ranging (RADAR) sensor.

13. The computer-implemented method of claim 9, wherein receiving the sensor data from the rear facing sensor comprises receiving sensor data from the rear facing sensor including sensor data corresponding to at least a portion of the trailer in a field of view of the rear facing sensor.

14. The computer-implemented method of claim 13, wherein the portion of the trailer in the field of view is a longitudinal side portion of the trailer.

15. The computer-implemented method of claim 9, wherein whether the autonomous vehicle coupled with the trailer is in a non-turning phase is determined based upon angular velocity measurements or vertical angular rate measurements.

16. The computer-implemented method of claim 9, wherein the predetermined threshold value for determining the rear facing sensor needs calibration is the hitch angle more than +2 degree or less than −2 degree, and the method further comprising applying corrections to the sensor data for calibrating the rear facing sensor.

17. An autonomous vehicle comprising:
a rear facing perception sensor mounted on a tractor of the autonomous vehicle;
at least one memory configured to store machine executable instructions; and
at least one processor coupled to the at least one memory and configured to execute the machine executable instructions to perform operations comprising:
receiving sensor data from the rear facing sensor, wherein the sensor data is expressed in a sensor coordinate system;
determining a vehicle coordinate system of the autonomous vehicle based upon a sensor coordinate system of the rear facing perception sensor;
determining a vehicle coordinate system of a trailer coupled with the autonomous vehicle based upon the sensor coordinate system and the sensor data;
computing a hitch angle between the autonomous vehicle and the trailer while the autonomous vehicle coupled with the trailer is in a non-turning phase, wherein the hitch angle corresponds to an angular difference in an alignment of the vehicle coordinate system of the trailer and the vehicle coordinate system of the autonomous vehicle; and
determining the rear facing perception sensor needs calibration based upon the hitch angle exceeding a predetermined threshold value.

18. The autonomous vehicle of claim 17, wherein the at least one processor is further configured to execute the machine executable instructions to determine whether the sensor data from the rear facing perception sensor needs to be adjusted for multi-source multi-modal sensor data fusion in response to the hitch angle exceeding the predetermined threshold value.

19. The autonomous vehicle of claim 17, wherein receiving the sensor data from the rear facing perception sensor comprises receiving sensor data from a light detection and ranging (LiDAR) sensor or a radio detection and ranging (RADAR) sensor corresponding to at least a portion of the trailer in a field of view of the rear facing sensor, and wherein the portion of the trailer in the field of view is a longitudinal side portion of the trailer.

20. The autonomous vehicle of claim 17, wherein the predetermined threshold value for determining the rear facing sensor needs calibration is the hitch angle more than +2 degree or less than −2 degree.
